(19) United States
(12) Patent Application Publication
(10) Pub. No.: US 2014/0061131 A1
(43) Pub. Date: Mar. 6, 2014

(54) SEPARATION METHOD

(71) Applicant: Kabushiki Kaisha Kobe Seiko Sho (Kobe Steel, Ltd.), Kobe-shi (JP)

(72) Inventors: Akira Matsuoka, Kobe-shi (JP); Koji Noishiki, Takasago-shi (JP)

(21) Appl. No.: 13/927,018

(22) Filed: Jun. 25, 2013

(30) Foreign Application Priority Data
Aug. 28, 2012 (JP) 2012-187631

(51) Int. Cl. B01D 11/04

(52) U.S. Cl. CPC B01D 11/0496
USPC 210/644

(57) ABSTRACT

A total solvent use amount is reduced while a final concentration of a specific element of a separation target in a target fluid is reliably decreased to a target value or less. In a separation method, a solvent greater than a theoretical amount of a solvent necessary for decreasing a concentration of a specific element in an extraction remaining liquid supplied from a second extraction stage as an immediately previous stage to the target value is supplied to a third micro channel of a third extraction stage as a final stage, an extraction liquid separated by a third settler of the third extraction stage as the final stage is distributed to a first extraction stage and the second extraction stage, and the extraction liquid distributed to a first micro channel of the first extraction stage and a second micro channel of the second extraction stage are used as solvent.

### BACKGROUND OF THE INVENTION

1. Field of the Invention

The present invention relates to a separation method of separating a specific element from a target fluid by dissolving the specific element from a target fluid containing the specific element to a solvent.

2. Description of the Related Art

Hitherto, there are known various separation methods of separating the specific element from the target fluid and an example of the separation method is illustrated in “Soko-ga-shiritai kagaku no hanashi-bunri gijyutsu (Curious chemical story—separation technique)” THE NIKKAN KOGYO SHIMBUN, LTD. (First Edition Jun. 28, 2008, p. 103) below.

Specifically, the “Curious chemical story ‘separation technique’” below discloses an extraction method of extracting a target element from a stock solution as a target fluid by a solvent as an example of the separation method. The extraction method disclosed in the “Curious chemical story ‘separation technique’” is a multi-stage extraction method of repeating an extraction operation using an extraction device configured by sequentially connecting a plurality of extraction stages each including a mixer (an agitation tank) and a settler. Specifically, in the extraction method, an extraction is performed by agitating a stock solution and a solvent in a mixer of a first extraction stage, and a mixed liquid of the stock solution and the solvent is introduced into a settler of the first extraction stage so as to be separated into an extraction liquid formed by the solvent having the target element dissolved therein and an extraction remaining liquid as a remaining liquid having a decreased concentration of the target element inside the settler by a difference in specific weight. Next, the extraction remaining liquid which is separated by the settler of the first stage is introduced into the mixer of the second extraction stage, and a new solvent is introduced into the mixer so as to be agitated, so that the extraction is performed again. The mixed liquid which is mixed by the mixer at the second stage is introduced into the settler of the second separation stage so as to be separated into an extraction liquid and an extraction remaining liquid as in the first stage. The agitation using the mixer and the separation using the settler are repeated until the fluid reaches the final separation stage.

### SUMMARY OF THE INVENTION

However, in the above-described method, when the stock solution supply flow rate increases or the specific element extraction ratio decreases due to a certain factor at the previous extraction stage, it is difficult to reliably decrease the concentration of the specific element in the extraction remaining liquid at the final extraction stage to the target value or less while preventing a significant increase in solvent amount.

Specifically, as a means that sets the concentration of the specific element in the extraction remaining liquid at the final extraction stage to the target value or less regardless of an increase in the stock solution supply flow rate or a decrease in the specific element extraction ratio at the previous extraction stage, a means that increases the amount of a new solvent supplied to the mixer of the final extraction stage is considered. However, in the above-described method, since new solvents are respectively supplied to the mixers of the respective separation stages as the previous stages of the final separation stage, the total solvent use amount is comparatively large. Further, when the solvent amount supplied to the mixer of the final extraction stage is further increased, the total solvent use amount increases, and hence a disadvantage in cost occurs. Accordingly, in the above-described method, it is difficult to reliably set the concentration of the specific element in the extraction remaining liquid at the final extraction stage to the target value or less and to reduce the total solvent use amount at the same time.

The present invention is made to solve the above-described problems, and it is an object of the present invention to reduce a total solvent use amount while reliably decreasing a final concentration of a specific element of a separation target in a target fluid to a target value or less.

In order to achieve the above-described object, according to an aspect of the present invention, there is provided a separation method of separating a specific element from a target fluid by using a separation device configured by connecting three separation stages or more each including an elution portion for eluting the specific element from the target fluid and a settler connected to the elution portion, the separation method including: causing the first separation stage among three separation stages or more connected to one another to elute the specific element from the target fluid to the solvent by bringing the solvent into contact with the target fluid using the elution portion and to separate a fluid derived from the elution portion into an elution fluid as the solvent having the specific element dissolved therein and a dissolved remaining fluid as the target fluid having a decreased concentration of the specific element using the settler; causing each separation stage from the second separation stage to elute the specific element from the dissolved remaining fluid to the solvent by bringing the solvent into contact with the dissolved remaining fluid separated by the settler of the immediately previous separation stage using the elution portion and to separate a fluid derived from the elution portion into an elution fluid and a dissolved remaining fluid using the settler of the separation stage; supplying a solvent greater than a theoretical amount of the solvent necessary for decreasing a concentration of the specific element in the dissolved remaining fluid supplied from the immediately previous separation stage to a target value to the elution portion of the final separation stage in the dissolved remaining fluid flowing direction of three separation stages or more connected to one another; and distributing the elution fluid separated by the settler of the final separation stage to two separation stages or more selected from the plurality of separation stages as the previous stages of the final separation stage so as to use the distributed elution fluid as the solvent in the elution portion of each separation stage distributing the elution fluid.

In the separation method, since the solvent greater than the theoretical amount of the solvent necessary for decreasing the concentration of the specific element in the dissolved remaining fluid supplied from the immediately previous separation stage to the target value is supplied to the elution portion of the final separation stage, the ratio of the solvent in the elution fluid produced in the final separation stage increases, and the concentration of the specific element in the elution fluid decreases. Further, since the dissolved remaining fluid of which the concentration of the specific element fairly decreases due to the gradual elution of the specific element at the respective separation stages as the previous stages is supplied to the final separation stage, the amount of the specific element eluted from the dissolved remaining fluid to the solvent in the elution portion at the final separation stage is originally small. For this reason, the concentration of the specific element in the elution fluid produced in the final separation stage considerably decreases. Accordingly, the elution fluid which is produced in the final separation stage has elution ability for sufficiently eluting the specific element from the target fluid or the dissolved remaining fluid at the previous stage of which the concentration of the specific element is comparatively high, and in the separation method, the elution fluid produced at the final separation stage is distributed to two separation stages or more selected from the plurality of previous separation stages so as to use the distributed elution fluid as the solvent in the elution portion of each separation stage. Accordingly, the total solvent use amount may be reduced by reusing the elution fluid produced at the final separation stage as the solvents at the previous stages while decreasing the concentration of the specific element of the dissolved remaining fluid or the target fluid to the sufficient value at each previous separation stage that receives the distributed elution fluid produced in the final separation stage. Further, in the separation method, since the solvent greater than the theoretical amount of the solvent necessary for decreasing the concentration of the specific element in the dissolved remaining fluid supplied from the immediately previous separation stage to the target value is supplied to the elution portion of the final separation stage as described above, even when the target fluid supply flow rate increases so that the amount of the fluid to be eluted in the elution portion of the final separation stage increases, the fluid is sufficiently eluted by the large amount of the solvent, so that the concentration of the specific element in the final target fluid (the dissolved remaining fluid) may be decreased to the target value or less. Further, even when the specific element elution ratio at the previous separation stage decreases and the concentration of the specific element in the dissolved remaining fluid to be supplied to the elution portion of the final separation stage increases, the dissolved remaining fluid is eluted by the large amount of the solvent, so that the concentration of the specific element in the final target fluid (the dissolved remaining fluid) may be decreased to the target value or less. Thus, in the separation method, the total solvent use amount may be reduced while reliably decreasing the final concentration of the specific element in the target fluid to the target value or less.

The separation method may further include: causing the first separation stage to elute the specific element from the target fluid to the solvent while the target fluid and the solvent are made to flow in a contact state with each other through a channel constituting the elution portion of the separation stage by using the channel through which a fluid continuously flows as the elution portion; and causing each separation stage from the second stage to elute the specific element from the dissolved remaining fluid to the solvent while the solvent and the dissolved remaining fluid separated by the settler of the immediately previous separation stage are made to flow the channel constituting the elution portion of the separation stage.

According to this configuration, since the target fluid may be continuously treated, the target fluid treatment efficiency may be improved.

In this case, a micro channel may be used as the channel that constitutes the elution portion of each separation stage.

According to this configuration, since the joined fluid of the target fluid and the solvent or the joined fluid of the dissolved remaining fluid and the solvent may flow through the micro channel while increasing the contact area per unit volume between the target fluid and the solvent or the contact area per unit volume between the dissolved remaining fluid and the solvent inside the micro channel constituting the elution portion of each separation stage, the satisfactory specific element elution efficiency (the separation efficiency) may be obtained. Further, since the target fluid (the dissolved remaining fluid) and the solvent may flow in the slag stream or double-layered stream state through the micro channel, the target fluid and the solvent are not actively mixed with each other, and the emulsification of the joined fluid of both fluids does not occur. For this reason, for example, compared to the case where the target fluid (the dissolved remaining fluid) and the solvent are actively agitated with each other in the mixer, the joined fluid coming out of the micro channel may be easily separated into the elution fluid and the dissolved remaining fluid by the settler. For this reason, it is possible to shorten the fluid staying time necessary for the separation in the settler and hence to further improve the continuous target fluid treatment efficiency.

As described above, according to the present invention, it is possible to reduce the total solvent use amount while reliably decreasing the final concentration of a specific element of a separation target in a target fluid to a target value or less.

### BRIEF DESCRIPTION OF THE DRAWINGS

FIG. 1 is a schematic diagram illustrating a configuration of an extraction device that is used in an extraction method according to an embodiment of the present invention.

FIG. 2 is a schematic diagram illustrating a configuration of an extraction device that is used in an extraction method according to a comparative example of an embodiment of the present invention.

FIG. 3 is a diagram illustrating an example of a relation between a solvent ratio and an extraction ratio.

### DESCRIPTION OF THE PREFERRED EMBODIMENTS

Hereinafter; preferred embodiments of the present invention will be described by referring to the drawings.

A separation method according to the present invention includes various methods, but in this embodiment, as an example of the separation method, an extraction method will be described which elutes a specific element from a target fluid to a solvent so as to extract the specific element from the target fluid.

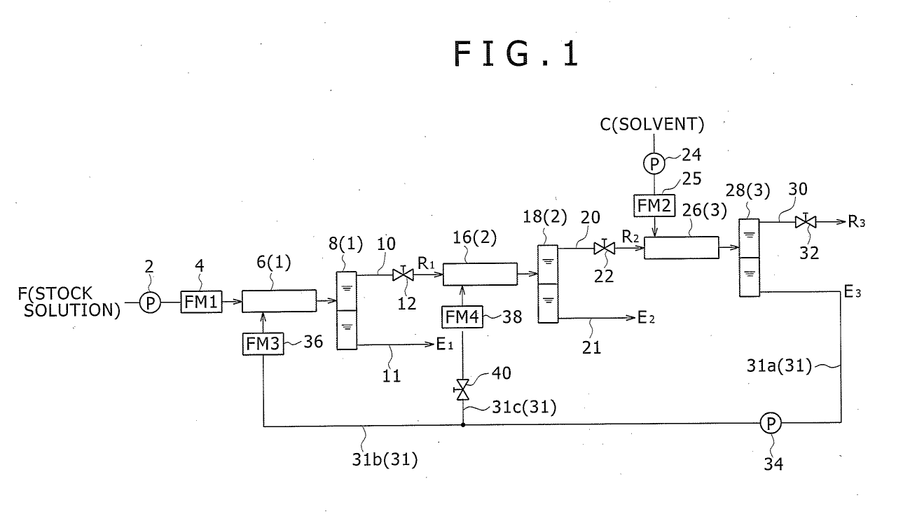

In the extraction method according to the embodiment, the extraction is performed by using the extraction device with the configuration illustrated in FIG. 1. The extraction device is included in the concept of the “separation device” of the present invention. The extraction device includes a first extraction stage 1, a second extraction stage 2, and a third extraction stage 3 which are sequentially connected to one another. Furthermore, these extraction stages 1, 2, and 3 are included in the concept of the “separation stage” of the present invention.

The first extraction stage 1 includes a first micro channel 6 and a first settler 8.

The first micro channel 6 is a microscopic channel which has a diameter corresponding to several millimeters, and causes a solvent and a stock solution as a target fluid containing a specific element to flow downstream side while contacting each other, so that the specific element is eluted from the stock solution to the solvent in this state. The first micro channel 6 is formed so that the stock solution and the solvent supplied thereto are joined to each other therein. Furthermore, in the first micro channel 6, an extraction liquid which is produced by the third extraction stage 3 as described below is used as the solvent. A first supply pump 2 is connected to the inlet side of the first micro channel 6 through a pipe. The pipe which connects the first supply pump 2 to the first micro channel 6 is provided with a first flowmeter 4. The first flowmeter 4 is used to detect the flow rate of the stock solution which is supplied (discharged) from the first supply pump 2 to the first micro channel 6.

The first settler 8 is a separation tank which is connected to the downstream side (the outlet side) of the first micro channel 6 so as to separate a fluid derived from the first micro channel 6 into an extraction liquid and an extraction remaining liquid by a difference in specific weight. Furthermore, the extraction liquid is a solvent in which the specific element eluted from the stock solution (the target fluid) is dissolved, and is included in the concept of the “elution fluid” of the present invention. Further, the extraction remaining liquid is the stock solution (the target fluid) of which the concentration of the specific element decreases after the elution of the specific element, and is included in the concept of the “dissolved remaining fluid” of the present invention.

The first settler 8 is connected with a first upper derivation path 10 and a first lower derivation path 11. The first upper derivation path 10 is connected to the upper portion of the first settler 8, and the first lower derivation path 11 is connected to the first settler 8 at a position lower than the connection portion of the first upper derivation path 10 with respect to the first settler 8. In the first settler 8, a light fluid as a fluid which has a small specific weight among the extraction liquid and the extraction remaining liquid floats toward the upside, and a heavy liquid as a fluid which has a large specific weight settles toward the downside. For this reason, the light fluid is derived from the first settler 8 to the first upper derivation path 10, and the heavy fluid is derived from the first settler 8 to the first lower derivation path 11. In the embodiment, the device is configured on the assumption that the extraction remaining liquid becomes the light fluid and the extraction liquid becomes the heavy fluid. The first upper derivation path 10 is provided with a first upper valve 12 which controls the flow rate of the extraction remaining liquid derived from the first settler 8 to the first upper derivation path 10.

The second extraction stage 2 includes a second micro channel 16 and a second settler 18.

The inlet side of the second micro channel 16 is connected with the downstream end of the first upper derivation path 10. The extraction remaining liquid which is separated by the first settler 8 is introduced into the second micro channel 16 through the first upper derivation path 10. The other configuration of the second micro channel 16 is the same as that of the first micro channel 6. Further, the configuration of the second settler 18 is the same as that of the first settler 8. The second settler 18 is connected with a second upper derivation path 20 and a second lower derivation path 21, and the second upper derivation path 20 is provided with a second upper valve 22. The configurations according to the second upper derivation path 20, the second lower derivation path 21, and the second upper valve 22 are the same as the above-described configurations according to the first upper derivation path 10, the first lower derivation path 11, and the first upper valve 12.

The third extraction stage 3 includes a third micro channel 26 and a third settler 28.

The inlet side of the third micro channel 26 is connected with the downstream end of the second upper derivation path 20 and is connected with a second supply pump 24 through a pipe. The extraction remaining liquid which is separated by the second settler 18 is introduced into the third micro channel 26 through the second upper derivation path 20. Further, the second supply pump 24 is used to supply the solvent (extraction) to the third micro channel 26, and the pipe which connects the second supply pump 24 to the third micro channel 26 is provided with a second flowmeter 25 which detects the flow rate of the solvent to be supplied from the second supply pump 24 to the third micro channel 26. In the embodiment, a new solvent is supplied only to the third micro channel 26 of the third extraction stage 3 as the final extraction stage in the target fluid flowing direction. The other configuration of the third micro channel 26 is the same as the configuration according to the second micro channel 16. Further, the configuration of the third settler 28 is the same as that of the second settler 18. The third settler 28 is connected with a third upper derivation path 30 which is similar to the second upper derivation path 20, and the third upper derivation path 30 is provided with a third upper valve 32 which is similar to the second upper valve 22.

Further, a third lower derivation path 31 is connected to the third settler 28 at a position lower than the connection portion of the third upper derivation path 30 with respect to the third settler 28. The third lower derivation path 31 includes an upstream connection path 31a which is connected to the third settler 28 and first and second branch paths 31b and 31c which are connected to the downstream end of the upstream connection path 31a and are branched therefrom. The first branch path 31b is connected to the inlet side of the first micro channel 6 of the first extraction stage 1, and the second branch path 31c is connected to the inlet side of the second micro channel 16 of the second extraction stage 2. The upstream connection path 31a is provided with a returning pump 34, the first branch path 31b is provided with a third flowmeter 36, and the second branch path 31c is provided with a fourth flowmeter 38 and a distribution flow rate control valve 40.

The returning pump 34 is used to deliver the extraction liquid derived from the third settler 28 to the upstream connection path 31a to the first micro channel 6 and the second micro channel 16 through the first branch path 31b and the second branch path 31c. The third flowmeter 36 is used to detect the flow rate of the extraction liquid to be supplied to the first micro channel 6 through the first branch path 31b. The fourth flowmeter 38 is used to detect the flow rate of the extraction liquid to be supplied to the second micro channel 16 through the second branch path 31c. The distribution flow rate control valve 40 controls the flow rate of the extraction liquid introduced from the third settler 28 to the second micro channel 16 through the second branch path 31c, and thus controls the distribution amount to the second micro channel 16 and the distribution amount to the first micro channel 6 among the extraction liquid supplied from the third settler 28.

Since the third lower derivation path 31 has the above-described configuration, the elution fluid which is separated by the third settler 28 is distributed to the first micro channel 6 of the first extraction stage 1 and the second micro channel 16 of the second extraction stage 2.

Next, an extraction method according to an embodiment using the extraction device with the above-described configuration will be described in detail below.

In the extraction method according to the embodiment, first, the first supply pump 2 supplies the stock solution (the target fluid) containing the specific element of the extraction target to the first micro channel 6, and the second supply pump 24 supplies the solvent (the extraction) to the third micro channel 26. As the stock solution, for example, an organic solvent such as dodecane containing phenol as the specific element of the extraction target is used. Then, as the solvent, for example, water or the like is used.

The stock solution which is supplied to the first micro channel 6 directly flows through the first micro channel 6 toward the downstream side so as to be introduced into the first settler 8, and passes from the first settler 8 through the first upper derivation path 10, the second micro channel 16, the second settler 18, and the second upper derivation path 20 so as to be introduced into the third micro channel 26. Then, the stock solution introduced into the third micro channel 26 and the solvent supplied from the second supply pump 24 to the third micro channel 26 are joined to each other inside the third micro channel 26, and the stock solution and the solvent which are joined to each other flow toward the downstream side inside the third micro channel 26 in the slag stream or double-layered stream state while contacting each other. While the stock solution and the solvent flow toward the downstream side inside the third micro channel 26 in the slag stream or double-layered stream state, the specific element of the extraction target is eluted from the stock solution to the solvent through the boundary face between the stock solution and the solvent so as to extract the specific element. Accordingly, the concentration of the specific element in the stock solution decreases by the amount in which the specific element is extracted to the solvent.

Subsequently, the extraction liquid as the solvent extracting the specific element and the extraction remaining liquid as the stock solution of which the concentration of the specific element decreases are discharged from the outlet of the third micro channel 26 and are introduced into the third settler 28. The liquid which is introduced into the third settler 28 is separated into the extraction remaining liquid as the light fluid and the extraction liquid as the heavy fluid due to a difference in specific weight, so that the extraction remaining liquid floats toward the upside inside the third settler 28 and the extraction liquid settles toward the downside therein.

Next, the extraction remaining liquid is derived from the third settler 28 to the third upper derivation path 30, and the extraction liquid is derived to the upstream connection path 31a of the third lower derivation path 31. The extraction liquid which is derived to the upstream connection path 31a is delivered by the returning pump 34 so as to be distributed to the first micro channel 6 and the second micro channel 16 through the first branch path 31b and the second branch path 31c. At this time, the extraction liquid is distributed at a predetermined flow rate ratio to the first micro channel 6 and the second micro channel 16 by the distribution flow rate control valve 40.

Since the stock solution is supplied to the first micro channel 6 by the first supply pump 2, the distributed extraction liquid is joined to the stock solution, and hence the specific element is eluted from the stock solution inside the first micro channel 6 using the extraction liquid as the solvent. The elution herein is performed as in the elution in the third micro channel 26.

Subsequently, the extraction remaining liquid as the stock solution of which the concentration of the specific element decreases and the extraction liquid of which the concentration of the specific element increases due to the dissolved specific element are discharged from the outlet of the first micro channel 6 and are introduced into the first settler 8. The joined fluid of the extraction liquid and the extraction remaining liquid introduced into the first settler 8 is separated into the extraction remaining liquid and the extraction liquid as in the separation in the third settler 28. The separated extraction remaining liquid is introduced into the second micro channel 16 through the first upper derivation path 10, and the extraction liquid is discharged through the first lower derivation path 11.

As in the case of the first micro channel 6, first, the stock solution and the extraction liquid introduced from the second branch path 31c are joined in the second micro channel 16 so that the specific element is eluted from the stock solution using the extraction liquid as the solvent. However, when the specific element is eluted (extracted) from the stock solution at the first extraction stage 1 and the liquid introduced from the first extraction stage 1 to the second micro channel 16 becomes the extraction remaining liquid, the extraction liquid introduced into the second micro channel 16 is eluted from the extraction remaining liquid. Then, the extraction remaining liquid of which the concentration of the specific element decreases and the extraction liquid of which the concentration of the specific element increases are discharged from the second micro channel 16 and are introduced into the second settler 18 so as to be separated into the extraction remaining liquid and the extraction liquid as in the case of the first settler 8. The extraction remaining liquid which is discharged from the second settler 18 is introduced into the third micro channel 26 through the second upper derivation path 20, and the extraction liquid is discharged through the second lower derivation path 21.

The extraction remaining liquid introduced through the second upper derivation path 20 and the solvent supplied from the second supply pump 24 are joined in the third micro channel 26 and are eluted as in the cases of the first micro channel 6 and the second micro channel 16. Here, a solvent greater than theoretical amount of the solvent necessary for decreasing the concentration of the specific element in the extraction remaining liquid introduced into the third micro channel 26 to the target value is supplied from the second supply pump 24 to the third micro channel 26.

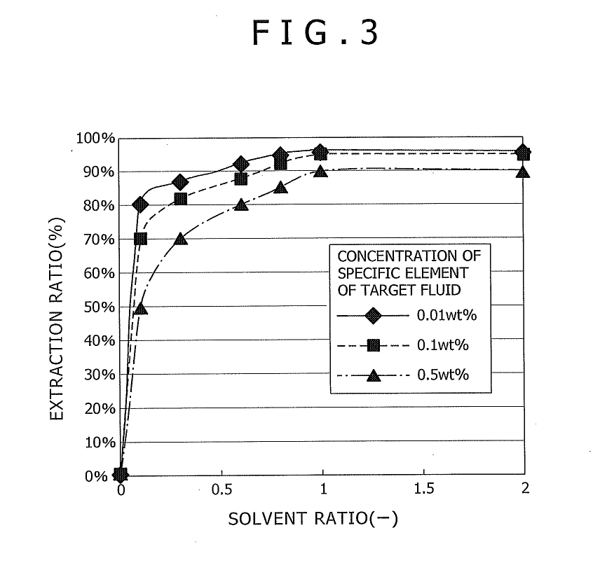

Specifically, as illustrated in FIG. 3, a relation between a solvent ratio as a volume ratio of the solvent with respect to the target fluid and an extraction ratio obtained when extracting the specific element from the target fluid by the solvent is obtained in advance. Furthermore, FIG. 3 is an example of a relation between the solvent ratio and the extraction ratio. Then, the extraction ratio necessary for decreasing the concentration of the specific element in the target fluid to the target value is calculated, the solvent ratio necessary for obtaining the calculated extraction ratio is calculated from the relation of FIG. 3, and then the theoretical amount of the solvent is calculated from the calculated solvent ratio. In a case where the concentration of the specific element in the target fluid is a value between the respective concentrations (0.01 wt %, 0.1 wt %, and 0.5 wt %) illustrated in FIG. 3, the solvent ratio is calculated by the interpolation method from the correlation curve corresponding to each concentration when obtaining the solvent ratio. Then, a solvent greater than the theoretical amount of the solvent calculated in this way is supplied from the second supply pump 24 to the third micro channel 26 per unit time.

By the elution in the third micro channel 26 with the above-described configuration, the concentration of the specific element in the extraction remaining liquid becomes lower than the target value, and the joined fluid of the extraction remaining liquid and the extraction liquid is introduced into the third settler 28. In the third settler 28, the extraction remaining liquid and the extraction liquid are separated. Then, the separated extraction remaining liquid is discharged as the final extraction remaining liquid through the third upper derivation path 30, and the separated extraction liquid is distributed at a predetermined flow rate ratio to the first micro channel 6 of the first extraction stage 1 and the second micro channel 16 of the second extraction stage 2 through the third lower derivation path 31.

As described above, the extraction method according to an embodiment is performed.

In the embodiment, since the solvent greater than the theoretical amount of the solvent necessary for decreasing the concentration of the specific element in the extraction remaining liquid supplied from the second extraction stage 2 as the immediately previous stage to the target value is supplied to the third micro channel 26 of the third extraction stage 3 as the final extraction stage, the ratio of the solvent in the extraction liquid produced in the final third extraction stage 3 increases, and the concentration of the specific element in the extraction liquid decreases. Further, since the extraction remaining liquid of which the concentration of the specific element fairly decreases due to the gradual elution of the specific element in the first extraction stage 1 and the second extraction stage 2 as the previous stages is supplied to the third micro channel 26 of the final third extraction stage 3, the amount of the specific element eluted from the supplied extraction remaining liquid to the solvent is originally small in the third micro channel 26 of the final third extraction stage 3. For this reason, the concentration of the specific element in the extraction liquid produced in the final third extraction stage 3 considerably decreases. Accordingly, the extraction liquid which is produced in the final third extraction stage 3 has elution ability for sufficiently eluting the specific element from the stock solution of which the concentration of the specific element is comparatively high in the first extraction stage 1 and the extraction remaining liquid from the first extraction stage 1 in the second extraction stage 2. Then, in the embodiment, the extraction liquid which is produced in the final third extraction stage 3 is distributed to the first extraction stage 1 and the second extraction stage 2 as the previous stages, and the distributed extraction liquids are used as the solvents in the micro channels 6 and 16 of the respective extraction stages 1 and 2. Accordingly, the extraction liquid produced in the final third extraction stage 3 is reused as the solvent in the first extraction stage 1 and the second extraction stage 2 while decreasing the concentration of the specific element of the stock solution or the extraction remaining liquid to the sufficient value at the first extraction stage 1 and the second extraction stage 2 that distribute the extraction liquid produced in the final third extraction stage 3, thereby reducing the total solvent use amount.

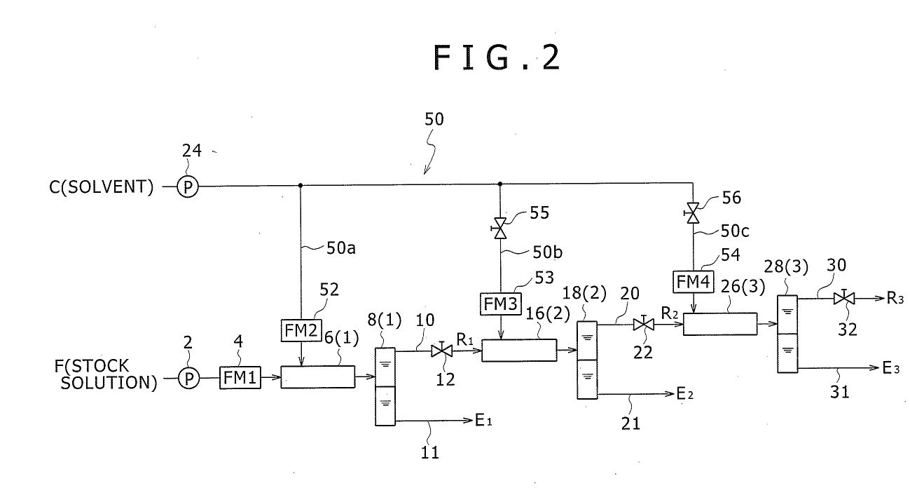

In general, as the multi-stage extraction method, an extraction method may be also considered which supplies a new solvent to each of the micro channels 6, 16, and 26 of the first to third extraction stages 1 to 3 using the extraction device having the configuration illustrated in FIG. 2 and elutes the specific element by the new solvents in the respective micro channels 6, 16, and 26. Specifically, in the extraction device, the pipe 50 which is connected to the second supply pump 24 for supplying the solvent is branched so as to be connected to each of the first to third micro channels 1 to 3. A branch path 50a of the pipe 50 connected to the first micro channel 6 is provided with a second flowmeter 52, a branch path 50b of the pipe 50 connected to the second micro channel 16 is provided with a third flowmeter 53 and a first flow rate control valve 55, and a branch path 50c of the pipe 50 connected to the third micro channel 26 is provided with a fourth flowmeter 54 and a second flow rate control valve 56. In the extraction method, the flow rate of the solvent supplied to the second micro channel 16 is controlled by the first flow rate control valve 55 and the flow rate of the solvent supplied to the third micro channel 26 is controlled by the second flow rate control valve 56, thereby controlling the flow rate of the remaining solvent supplied to the first micro channel 6 by such flow rate control. In the extraction method, since the new solvent is supplied to the micro channel 6 of each of the extraction stages 1 to 3, the solvent use amount increases.

On the contrary, in the embodiment, the new solvent is supplied only to the third micro channel 26 of the third extraction stage 3, and the extraction liquid produced in the third micro channel 26 is reused as the solvent in the first micro channel 6 of the first extraction stage 1 and the second micro channel 16 of the second extraction stage 2 as described above. For this reason, it is possible to reduce the total solvent use amount compared to the extraction method using the extraction device illustrated in FIG. 2.

Further, in the embodiment, since the solvent greater than the theoretical amount of the solvent necessary for decreasing the concentration of the specific element in the extraction remaining liquid supplied from the second extraction stage 2 as the immediately previous stage to the target value is supplied to the third micro channel 26 of the third extraction stage 3 as the final extraction stage as described above, even when the stock solution supply flow rate increases and the amount of the liquid to be subjected to the elution treatment at the third micro channel 26 of the third extraction stage 3 increases, the liquid may be sufficiently eluted by the large amount of the solvent so that the concentration of the specific element in the final extraction remaining liquid decreases to the target value or less. Further, even when the extraction ratio (the elution ratio) of the specific element in the first extraction stage 1 and/or the second extraction stage 2 decreases and the concentration of the specific element in the extraction remaining liquid supplied to the third micro channel 26 of the third extraction stage 3 increases, the extraction remaining liquid is eluted by the large amount of the solvent, so that the concentration of the specific element in the final extraction remaining liquid may be decreased to the target value or less. Thus, in the embodiment, it is possible to reduce the total solvent use amount while reliably decreasing the concentration of the specific element in the final extraction remaining liquid to the target value or less.

Further, in the embodiment, since the micro channels 6, 16, and 26 which perform the elution (the extraction) while causing the fluid continuously to flow are used as the elution portion which performs the elution (the extraction) in the respective extraction stages 1, 2, and 3, the target fluid may be continuously treated, and hence the target fluid treatment efficiency may be improved.

Further, in the embodiment, the stock solution and the extraction liquid as the solvent from the third extraction stage 3 flow in the first micro channel 6 of the first extraction stage 1 while contacting each other, the extraction remaining liquid from the first extraction stage 1 and the extraction liquid as the solvent from the third extraction stage 3 flow in the second micro channel 16 of the second extraction stage 2 while contacting each other, and the extraction remaining liquid from the third extraction stage 2 and the new solvent flow in the third micro channel 26 of the third extraction stage 3 while contacting each other, thereby increasing the contact area per unit volume of the solvent and the target fluid inside the micro channels 6, 16, and 26 having microscopic channel diameter of the respective extraction stages 1, 2, and 3. For this reason, the satisfactory extraction efficiency (the satisfactory separation efficiency) of the specific element may be obtained. Further, since the target fluid and the solvent may flow in the slag stream or double-layered stream state through the micro channels 6, 16, and 26, the target fluid and the solvent are not actively mixed with each other, and the emulsification of the joined fluid of both fluids does not occur. For this reason, for example, compared to the case where the target fluid and the solvent are actively mixed with each other by agitation in a mixer, the joined fluid coming out of the micro channels 6, 16, and 26 may be easily separated into the extraction liquid and the extraction remaining liquid by the settlers 8, 18, and 28. For this reason, it is possible to shorten the fluid staying time necessary for the separation in the settlers 8, 18, and 28, and hence to further improve the continuous target fluid treatment efficiency.

### EXAMPLE

Hereinafter, a result of a simulation based on an experiment result performed to examine the effect of the extraction method according to an embodiment of the present invention will be described. Furthermore, the result to be described below is only the result in a set experiment system and a set condition. Thus, when the experiment system and/or the condition changes, the result changes depending on the system and/or condition.

First, a simulation was performed with respect to an experiment system in which dodecane including phenol as a specific element was set as a target fluid (stock solution) and the phenol was extracted by water as a solvent from the target fluid. As the simulation condition, a condition was set such that a stock solution treatment flow rate was 0.5 m³ per unit time, an initial concentration of the phenol in the stock solution was 0.5 wt % (percentage by weight), and the phenol was extracted from the target fluid so that the concentration of the phenol in the final extraction remaining liquid became a target value of 0.0026 wt % or less. Then, a simulation was performed under such an experiment system and such a condition with respect to a case (Case 1) in which the extraction method using the extraction device of FIG. 2 was performed and cases (Case 3 and Case 4) in which the extraction method was performed using the extraction device of FIG. 1 according to the embodiment. Further, the same simulation was performed with respect to a case (Case 2) in which the solvent use amount of Case 1 was decreased by the extraction method using the extraction device of FIG. 2. Furthermore, in Case 3 and Case 4, the amount of the solvent supplied to the third micro channel 26 of the third extraction stage 3 as the final extraction stage was set to be different. Such a simulation result is illustrated in Table 1 below. Furthermore, Table 1 indicates the amount per unit time as the solvent supply amount and the total solvent use amount (the total use amount at the entire extraction stages).

TABLE 1

| | | CASE 1 | | CASE 2 | | CASE 3 | | CASE 4 | |
|---|---|---|---|---|---|---|---|---|---|
| FIRST | SOLVENT | 0.25 | m³ | 0.15 | m³ | 0.17 | m³ | 0.20 | m³ |
| EXTRACTION | SUPPLY | | | | | | | | |
| STAGE | AMOUNT | | | | | | | | |
| | PHENOL | 0.5 | wt % | 0.5 | wt % | 0.514 | wt % | 0.512 | wt % |
| | CONCENTRATION | | | | | | | | |
| | OF TARGET | | | | | | | | |
| | FLUID | | | | | | | | |
| | EXTRACTION | 75% | | 70% | | 70% | | 73% | |
| | RATIO | | | | | | | | |
| SECOND | SOLVENT | 0.25 | m³ | 0.15 | m³ | 0.17 | m³ | 0.20 | m³ |
| EXTRACTION | SUPPLY | | | | | | | | |
| STAGE | AMOUNT | | | | | | | | |
| | PHENOL | 0.125 | w % | 0.15 | wt % | 0.167 | wt % | 0.151 | wt % |
| | CONCENTRATION | | | | | | | | |
| | OF TARGET | | | | | | | | |
| | FLUID | | | | | | | | |
| | EXTRACTION | 83% | | 75% | | 82% | | 84% | |
| | RATIO | | | | | | | | |
| THIRD | SOLVENT | 0.25 | m³ | 0.15 | m³ | 0.33 | m³ | 0.40 | m³ |
| EXTRACTION | SUPPLY | | | | | | | | |
| STAGE | AMOUNT | | | | | | | | |
| | PHENOL | 0.02125 | wt % | 0.0375 | wt % | 0.031 | wt % | 0.025 | wt % |
| | CONCENTRATION | | | | | | | | |
| | OF TARGET | | | | | | | | |
| | FLUID | | | | | | | | |

| | | | | |
|---|---|---|---|---|
| EXTRACTION | 88% | 80% | 92% | 94% |
| RATIO | | | | |

| | | | | | | | | |
|---|---|---|---|---|---|---|---|---|
| PHENOL CONCENTRATION | 0.0026 | wt % | 0.0075 | wt % | 0.0026 | wt % | 0.0015 | wt % |
| OF FINAL EXTRACTION | | | | | | | | |
| REMAINING LIQUID | | | | | | | | |
| TOTAL SOLVENT USE | 0.75 | m³ | 0.45 | m³ | 0.33 | m³ | 0.40 | m³ |
| AMOUNT | | | | | | | | |

### (Case 1)

In Case 1, in the extraction method using the extraction device of FIG. 2, a condition was set in which a new solvent was supplied to each of the micro channels 6, 16, and 26 of the extraction stages 1 to 3 at the flow rate of 0.25 m³ per unit time so that the solvent ratio with respect to the target fluid (the stock solution or the extraction remaining liquid at the previous stage) became 0.5. In this case, the concentration of phenol in the final extraction remaining liquid decreases to 0.0026 wt % as the target value, and the solvent use amount becomes 0.75 m³ per unit time in total.

### (Case 2)

In Case 2, in the extraction method using the extraction device of FIG. 2, a condition was set in which a new solvent was supplied to each of the micro channels 6, 16, and 26 of the extraction stages 1 to 3 at the flow rate of 0.15 m³ per unit time so that the solvent ratio with respect to the target fluid (the stock solution or the extraction remaining liquid at the previous stage) became 0.3. That is, in Case 2, the amount of the solvent which is supplied to the micro channels 6, 16, and 26 of the extraction stages 1 to 3 decreases compared to Case 1. In this case, the total solvent use amount becomes 0.45 m³ per unit time and hence decreases compared to Case 1. However, the concentration of phenol in the final extraction remaining liquid becomes 0.0075 wt % and becomes higher than the target value (0.0026 wt %).

### (Case 3)

In Case 3, in the extraction method using the extraction device of FIG. 1 according to the embodiment, a new solvent is supplied to the third micro channel 26 of the third extraction stage 3 as the final extraction stage at the flow rate of 0.33 m³ per unit time so that the solvent ratio with respect to the target fluid (the extraction remaining liquid at the previous stage) becomes 0.66, and the extraction liquid produced in the third extraction stage 3 is distributed at the flow rate of 0.17 m³ per unit time to each of the first micro channel 6 of the first extraction stage 1 and the second micro channel 16 of the second extraction stage 2. In Case 3, the concentration of phenol in the final extraction remaining liquid becomes 0.0026 wt %. Thus, as in Case 1, the concentration may be decreased to the target value and the total solvent use amount becomes 0.33 m³ per unit time, so that the use amount is considerably smaller than that of Case 1. The solvent supply amount with respect to the third micro channel 26 of the third extraction stage 3 in Case 3 is an example of the theoretical amount necessary for decreasing the concentration of phenol (the specific element) in the target fluid to be supplied to the third micro channel 26 to the target value.

### (Case 4)

In Case 4, in the extraction method using the extraction device of FIG. 1 according to the embodiment, a new solvent is supplied to the third micro channel 26 of the third extraction stage 3 at the flow rate of 0.40 m³ per unit time so that the solvent ratio with respect to the target fluid (the extraction remaining liquid at the previous stage) becomes 0.8, and the extraction liquid produced in the third extraction stage 3 is distributed at the flow rate of 0.20 m³ per unit time to each of the first micro channel 6 of the first extraction stage 1 and the second micro channel 16 of the second extraction stage 2. Case 4 is an example of the extraction method according to the embodiment, and the solvent supply amount with respect to the third micro channel 26 is larger than, the theoretical amount. In Case 4, the concentration of phenol in the final extraction remaining liquid becomes 0.0015 wt %, and hence may become lower than the target value of 0.0026 wt %. Further, in Case 4, the total solvent use amount becomes 0.40 m³ per unit time. That is, in Case 4, the total solvent use amount becomes slightly larger than that of Case 3, but the total solvent use amount may become considerably smaller than that of Case 1. Further, the concentration of phenol in the final extraction remaining liquid may become considerably smaller than the target value.

Next, a result of a simulation will be described which is performed by changing the distribution ratio of the extraction liquid produced in the third extraction stage 3 as the final extraction stage with respect to the first micro channel 6 of the first extraction stage 1 and the second micro channel 16 of the second extraction stage 2 in the extraction method using the extraction device of FIG. 1 according to the embodiment. In the simulation, the experiment system and the condition are the same as those of the above-described simulation, and the new solvent supply amount with respect to the third micro channel 26 of the third extraction stage 3 is equal to the supply amount (per unit time 0.40 m³) as in Case 4. Then, in the simulation, only the extraction liquid distribution ratio with respect to the first micro channel 6 and the second micro channel 16 was respectively set to different ratios in the first to fifth examples. The simulation result is illustrated in Table 2 below.

TABLE 2

| | | FIRST | SECOND | THIRD | FOURTH | FIFTH |
|---|---|---|---|---|---|---|
| | | EXAMPLE | EXAMPLE | EXAMPLE | EXAMPLE | EXAMPLE |
| FIRST | SOLVENT | 0.07 m³ | 0.13 m³ | 0.20 m³ | 0.27 m³ | 0.33 m³ |
| EXTRACTION | SUPPLY | | | | | |
| STAGE | AMOUNT | | | | | |
| | PHENOL | 0.506 wt % | 0.509 wt % | 0.512 wt % | 0.515 wt % | 0.521 wt % |
| | CONCENTRATION | | | | | |
| | OF | | | | | |
| | TARGET | | | | | |
| | FLUID | | | | | |
| | EXTRACTION | 53% | 66% | 73% | 77% | 81% |
| | RATIO | | | | | |
| SECOND | SOLVENT | 0.33 m³ | 0.27 m³ | 0.20 m³ | 0.13 m³ | 0.07 m³ |
| EXTRACTION | SUPPLY | | | | | |
| STAGE | AMOUNT | | | | | |
| | PHENOL | 0.268 wt % | 0.190 wt % | 0.151 wt % | 0.125 wt % | 0.103 wt % |
| | CONCENTRATION | | | | | |
| | OF | | | | | |
| | TARGET | | | | | |
| | FLUID | | | | | |
| | EXTRACTION | 87% | 85% | 84% | 80% | 74% |
| | RATIO | | | | | |
| THIRD | SOLVENT | 0.40 m³ | 0.40 m³ | 0.40 m³ | 0.40 m³ | 0.40 m³ |
| EXTRACTION | SUPPLY | | | | | |
| STAGE | AMOUNT | | | | | |
| | PHENOL | 0.036 wt % | 0.028 wt % | 0.025 wt % | 0.025 wt % | 0.027 wt % |
| | CONCENTRATION | | | | | |
| | OF | | | | | |
| | TARGET | | | | | |
| | FLUID | | | | | |
| | EXTRACTION | 94% | 94% | 94% | 94% | 94% |
| | RATIO | | | | | |

| | | | | | |
|---|---|---|---|---|---|
| PHENOL | 0.0022 wt % | 0.0016 wt % | 0.0015 wt % | 0.0014 wt % | 0.0016 wt % |
| CONCENTRATION OF | | | | | |
| FINAL EXTRACTION | | | | | |
| REMAINING LIQUID | | | | | |
| TOTAL SOLVENT USE | 0.40 m³ | 0.40 m³ | 0.40 m³ | 0.40 m³ | 0.40 m³ |
| AMOUNT | | | | | |

According to the simulation result, the concentration of phenol in the final extraction remaining liquid becomes the lowest value (0.0014 wt %) by the fourth example in which the extraction liquid produced in the third extraction stage 3 is distributed at the flow rate of 0.27 m³ per unit time to the first micro channel 6 of the first extraction stage 1 and is distributed at the flow rate of 0.13 m³ per unit time to the second micro channel 16 of the second extraction stage 2 under the set experiment system and the set condition. Thus, it is found that the extraction effect may be improved the most by this extraction liquid distribution ratio.

Furthermore, the embodiments disclosed herein need to be considered as examples in every respect and do not limit the present invention. The scope of the present invention is illustrated in the scope of claims instead of the description of the above-described embodiments, and includes a meaning equivalent to the scope of claims and all modifications within the scope.

For example, in the above-described embodiments, the target fluid and the solvent are all liquids, but any one of the target fluid and the solvent may be also a gas.

Further, the light fluid which is separated by the settler may be the extraction liquid and the heavy fluid may be the extraction remaining liquid. In this case, the lower derivation path connected to the settler at the previous stage may be connected to the micro channel at the next stage so as to introduce the extraction remaining liquid derived from the settler at the previous stage to the lower derivation path into the micro channel at the next stage. Then, the upper derivation path connected to the settler at the final stage may be branched and connected to the plurality of micro channels at the previous stages so as to distribute the extraction liquid (the light fluid) derived from the settler at the final stage to the upper derivation path to the plurality of micro channels at the previous stages.

Further, in the above-described embodiment, the extraction method has been described as an example of the separation method, but the present invention is not limited to the extraction method. As another embodiment of the separation method, for example, an absorption method may be exemplified which dissolves the specific element from the target fluid to the solvent and absorbs the specific element. The present invention may be applied even to the absorption method, and the absorption method may be performed by using the absorption device with the same configuration as that of the extraction device of the above-described embodiment. In this case, the respective extraction stages respectively become the absorption stages that absorb the specific element from the target fluid. In the absorption method, for example, a gas including CO₂ as a specific element is set as a target fluid and CO₂ is absorbed from the target fluid to water as a solvent. In this case, the solvent (water) that absorbs the specific element (CO₂) becomes a heavy fluid, and is included in the concept of the “elution fluid” of the present invention. Further, the gas as the target fluid from which the specific element (CO₂) is absorbed becomes a light fluid, and is included in the concept of the “dissolved remaining fluid” of the present invention.

Further, the elution portion of the present invention is not limited to the micro channel. That is, the elution portion of the present invention may employ any configuration in which the target fluid and the solvent contact each other so as to elute the specific element from the target fluid to the solvent. For example, an agitation layer such as a mixer or various channels other than the micro channel causing the target fluid and the solvent to continuously flow therethrough may be used as the elution portion of the present invention. Furthermore, as the channel other than the micro channel, a pipe which is formed as various kinds of tubes or a channel which has a diameter considerably larger than the micro channel and is formed inside the separation device may be used. However, it is desirable to use a channel capable of causing the target fluid and the solvent to flow therethrough as a joined fluid that may be easily separated from each other. Further, the separation stage is not limited to three stages, and the separation method according to the present invention may be performed by using a device in which four separation stages or more are sequentially connected to one another. In the above-described embodiments, the second extraction stage 2 as the previous stage of the final third extraction stage 3 and the third extraction stage 3 correspond to “two separation stages or more selected from the plurality of separation stage as the previous stages of the final separation stage” of the present invention. However, in a case where four separation stages or more are provided, there is no need to essentially distribute the elution fluid produced in the final separation stage to the first to third separation stages as the previous stages of the final separation stage. That is, a separation stage may exist which does not receive the distributed elution fluid produced in the final separation stage among the plurality of separation stages as the previous stages. For example, in a case where four separation stages are provided, a configuration may be employed in which the elution fluid produced in the final separation stage (the fourth separation stage) is distributed only to the first and second separation stages and the elution fluid is not distributed to the third separation stage. Alternatively, a configuration may be employed in which the elution fluid produced in the final separation stage is distributed only to the second and third separation stages and the elution fluid is not distributed to the first separation stage. Alternatively, a configuration may be employed in which the elution fluid produced in the final separation stage is distributed only to the first and third separation stages and the elution fluid is not distributed to the second separation stage. Furthermore, the separation stage which does not receive the distributed elution fluid produced in the final separation stage may receive a new solvent or an elution fluid produced in the stage subsequent to the separation stage.

Further, a configuration may be employed in which the elution fluid discharged from the final separation stage is distributed and supplied to two separation stages or more as the previous stages and the elution fluid discharged from the separation stage immediately before the final separation stage is supplied to the separation stage as the farther previous stage.

What is claimed is:

1. A separation method of separating a specific element from a target fluid by using a separation device configured by connecting three separation stages or more each including an elution portion for eluting the specific element from the target fluid and a settler connected to the elution portion, the separation method comprising:
causing the first separation stage among the three separation stages or more connected to one another to elute the specific element from the target fluid to a solvent by bringing the solvent into contact with the target fluid using the elution portion and to separate a fluid derived from the elution portion into an elution fluid as the solvent having the specific element dissolved therein and a dissolved remaining fluid as the target fluid having a decreased concentration of the specific element using the settler;
causing each separation stage from the second separation stage to elute the specific element from the dissolved remaining fluid to the solvent by bringing the solvent into contact with the dissolved remaining fluid separated by the settler of the immediately previous separation stage using the elution portion and to separate a fluid derived from the elution portion into an elution fluid and a dissolved remaining fluid using the settler of the separation stage;
supplying a solvent greater than a theoretical amount of the solvent necessary for decreasing a concentration of the specific element in the dissolved remaining fluid supplied from the immediately previous separation stage to a target value to the elution portion of a final separation stage in the dissolved remaining fluid flowing direction of three separation stages or more connected to one another; and
distributing the elution fluid separated by the settler of the final separation stage to two separation stages or more selected from the plurality of separation stages as the previous stages of the final separation stage so as to use the distributed elution fluid as the solvent in the elution portion of each separation stage distributing the elution fluid.

2. The separation method according to claim 1, further comprising:
causing the first separation stage to elute the specific element from the target fluid to the solvent while the target fluid and the solvent are made to flow in a contact state with each other through a channel constituting the elution portion of the separation stage by using the channel through which a fluid continuously flows as the elution portion; and
causing each separation stage from the second stage to elute the specific element from the dissolved remaining fluid to the solvent while the solvent and the dissolved remaining fluid separated by the settler of the immediately previous separation stage are made to flow the channel constituting the elution portion of the separation stage.

3. The separation method according to claim 2,
wherein a micro channel is used as the channel that constitutes the elution portion of each separation stage.
